(19) United States
(12) Patent Application Publication
(10) Pub. No.: US 2021/0354562 A1
(43) Pub. Date: Nov. 18, 2021

(54) Vehicle Console Device Charging Table

(71) Applicant: Robert Higaki, Watsonville, CA (US)

(72) Inventor: Robert Higaki, Watsonville, CA (US)

(21) Appl. No.: 16/875,722

(22) Filed: May 15, 2020

(51) Int. Cl. B60L 1/00; B60R 11/00; H02J 7/00

(52) U.S. Cl. CPC B60L 1/00; B60R 11/00; B60R 2011/0075; B60R 2011/0007; H02J 7/0044

(57) ABSTRACT

A console cover apparatus has a first and a second side wall having a common height, spaced apart by a dimension greater than a width of a console between front seats of a vehicle, a front wall and a rear wall joined to the side walls, the front wall and the rear wall extending to a height at least equal to the common height of the first and second side walls, and a top surface joined to the side walls or the front and rear walls, or both, in a manner to present the top surface horizontally, the top surface recessed below the common height of the side walls and the front and rear walls, such that an upper extension of the side walls and the front and rear walls provides a barrier around the four sides of the top surface.

### BACKGROUND OF THE INVENTION

### 1. Field of the Invention

The present invention is in the field of automobile aftermarket products and pertains particularly to a mobile charging table apparatus for charging mobile devices in a vehicle.

### 2. Discussion of the State of the Art

Auto aftermarket accessories are known for consumers seeking to modify or add a feature to their personal automobiles. Many aftermarket accessories require in-dash mounting or some other vehicle compartment mounting depending on the accessory. Traditionally, charging devices for use in an automobile include plug-in devices that fit directly into a cigarette lighter socket for many vehicles.

Newer vehicles may have universal serial bus (USB) charging ports and three-pronged alternating current (AC) charging ports. Users typically connect their devices to these charging ports by cable conductors and may place devices on existing vehicle compartment surfaces like a vehicle dashboard top surface, a center console top surface. They may hold the charging devices in their laps. The charging devices may slip off dashboard and console surfaces when the vehicle is in motion. Devices connected to a charging hub may be held in charging position by the hub, but the hub with one or more charging devices may slip off a surface like a console top or dashboard top.

Therefore, what is clearly needed is a console cover table that may be quickly set up to provide a table with a flat surface for staging mobile devices being charged by the vehicle in a manner that eliminates the problems described above.

### BRIEF SUMMARY OF THE INVENTION

In one embodiment of the present invention a console cover apparatus is provided, comprising a first and a second side wall having a common height, spaced apart by a dimension greater than a width of a console between front seats of a vehicle, a front wall and a rear wall joined to the side walls, the front wall and the rear wall extending to a height at least equal to the common height of the first and second side walls, and a top surface joined to the side walls or the front and rear walls, or both, in a manner to present the top surface horizontally, the top surface recessed below the common height of the side walls and the front and rear walls, such that an upper extension of the side walls and the front and rear walls provides a barrier around the four sides of the top surface.

In one embodiment the front wall or the rear wall, or both, extend upward to a height greater than the common height, such that the barrier at the back or the front, or both, around the top surface is greater than at the sides. Also, in one embodiment the apparatus is a single molded contiguous piece of a polymer material. In one embodiment the apparatus further comprises support elements joined to an inside surface of the side walls or the front and rear walls, or both, and the top surface is a separate piece that rests on the support element as a shelf, such that the top surface may be lifted up and out for access to the console. And in one embodiment the top surface has a handle facing upward to facilitate withdraw of the top surface from the support elements.

In one embodiment the top surface has one or more magnetically permeable metal plates in or below the surface. Also, in one embodiment the top surface is covered with a material having a high coefficient of friction. In one embodiment the material is applied as a coating to the top surface. And in one embodiment the top surface comprises openings, slots, or other relief features for routing wires.

In another aspect of the invention a method for constraining articles in a vehicle is provided, comprising creating a console cover apparatus having a first and a second side wall having a common height, spaced apart by a dimension greater than a width of a console between front seats of a vehicle, a front wall and a rear wall joined to the side walls, the front wall and the rear wall extending to a height at least equal to the common height of the first and second side walls, and a top surface joined to the side walls or the front and rear walls, or both, in a manner to present the top surface horizontally, the top surface recessed below the common height of the side walls and the front and rear walls, such that an upper extension of the side walls and the front and rear walls provides a barrier around the four sides of the top surface, and placing the console cover apparatus over the console between the front seats with the side walls to each side of the console, such that the top surface provides a support with barriers on all four sides, such that articles placed on the top surface cannot slide off.

In one embodiment the method further comprises making the front wall or the rear wall, or both, extend upward to a height greater than the common height, such that the barrier at the back or the front, or both, around the top surface is greater than at the sides. Also, in one embodiment the method comprises molding the apparatus as a single molded contiguous piece of a polymer material. Also, in one embodiment the method comprises joining support elements to an inside surface of the side walls or the front and rear walls, or both, so that the top surface is a separate piece that rests on the support element as a shelf, such that the top surface may be lifted up and out for access to the console. In one embodiment the method comprises joining a handle facing upward to the top surface to facilitate withdraw of the top surface from the support elements. And in one embodiment the method comprises placing one or more magnetically permeable metal plates in or below the top surface.

In one embodiment the method comprises covering the top surface with a material having a high coefficient of friction. IN one embodiment the method comprises applying the material as a coating to the top surface. And in one embodiment the method comprises a top surface with openings, slots, or other relief features for routing wires.

### BRIEF DESCRIPTION OF THE SEVERAL VIEWS OF THE DRAWINGS

FIG. 1 is a perspective view of a console cover table according to an embodiment of the present invention.

FIG. 2 is a front elevation view of the console cover table of FIG. 1.

FIG. 3 is a rear elevation view of the console cover table of FIG. 1.

FIG. 4 is a side elevation view of the console cover table of FIG. 1.

FIG. 5 is a top view of the console cover table of FIG. 1.

FIG. 6 is a front perspective view of the console cover table of FIG. 1.

### DETAILED DESCRIPTION OF THE INVENTION

In various embodiments described in enabling detail herein the inventor provides a unique console cover table that may be quickly set up over a console in a vehicle for use as a stable surface for charging mobile devices. In various embodiments the console cover table may hold other articles than mobile devices requiring charging. The present invention is described using the following examples, which may describe more than one relevant embodiment falling within the scope of the invention.

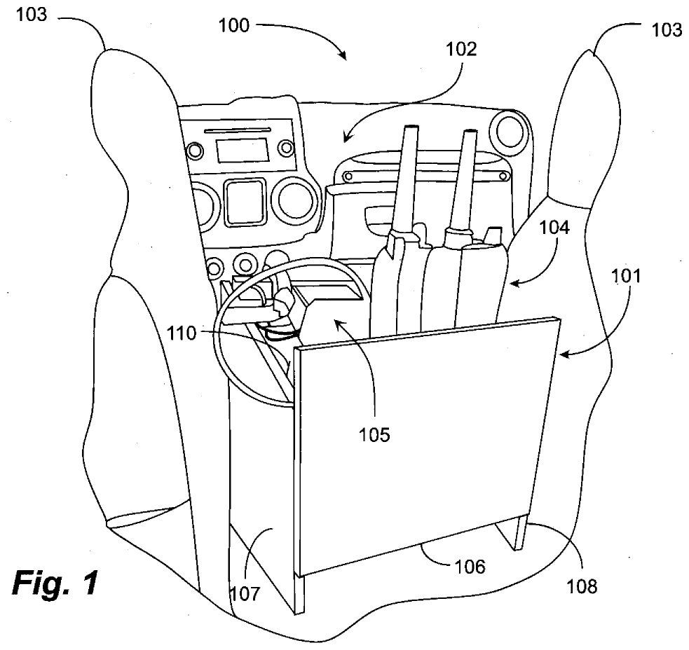

FIG. 1 is a perspective view of a console cover table 101 according to an embodiment of the present invention, in place on a vehicle center console. Console cover table 101 is adapted to fit over a center console located between two vehicle seats illustrated herein as seats 103 (driver and passenger seats). The seats are only partially seen to each side of the table. Console cover table 101 has a rectangular form in this embodiment. Console cover table 101 has a length dimension, a width dimension, and a height dimension that somewhat exceed the same dimensions in a center console. Console cover table 101 may be manufactured in different dimensions for specific vehicle model consoles.

Console cover table 101 may be fabricated of any one of a variety of suitable materials, such as wood, fiberboard, or plastic sheets, or of a polymer material that may be resistant to ultraviolet light (UV) damage. Other materials may be used in other embodiments. Console cover table 101 may be fabricated from several parts adapted to be fastened or fitted together using conventional hardware and fastening methods and materials. In one embodiment, console cover table 101 may be molded in a single contiguous piece. In another embodiment console cover table 101 may include more than one molded part that may be assembled to form the console cover table. Console cover table 101 may include plastic or wooden parts and or metal components without departing from the spirit and scope of the invention.

Console cover table 101 in this example has two sidewalls, a sidewall 107 (left) and a sidewall 108 (right). Console cover table 101 also comprises also a rear wall 106, and a front wall (109) that is not visible in this view. Console cover table 101 has a table surface 110 extending horizontally and substantially orthogonal to the sidewalls, front wall.

Table surface 110 in a preferred embodiment is a recessed surface where sidewalls 107 and 108 extend in height past the top surface, to form barriers at both supporting long sides of the table. Rear wall 106 may extend in height well past the top surface 110. Table surface 110 in this example supports charging mobile radio phones 104 and electronic battery chargers 105. The recessed nature of table surface 110 creates a box boundary that extends past table surface wall 110 in height. Rear wall 106 extends well above table surface 110.

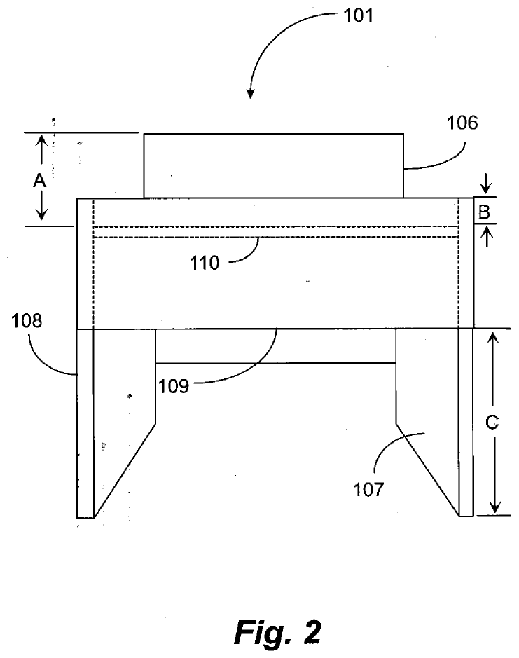

FIG. 2 is a front perspective view of console cover table 101 of FIG. 1. Console cover table 101 includes a front wall 109 which may extend to the same height as sidewalls 107 and 108. Front wall 106 in this example is less in height than the side walls by dimension C, and this difference may vary in different applications, dependent partly on the shape of the center console to which the table may be applied.

Dimension A is a height dimension from the top surface 110 to the top edge of the rear wall. This added height aids in preventing devices and articles on the table from sliding or falling off the back of console cover table 101. Dimension B is the height from the top surface 110 to the top edge of the front wall and the top edges of sidewalls 107 and 108. These raised edges are to prevent charging devices and other articles from sliding off console cover table 101. Dimension C represents a difference in height of the front wall and the side walls. This difference may vary widely in different applications and depends at least ion part on console shapes.

Dimensions A and B may be held relatively constant in fabrication specifications for console cover tables fabricated for different models having different center console profiles. Overall length, width, and height dimensions for console cover table 101 may vary considerably without departing from the spirit and scope of the present invention.

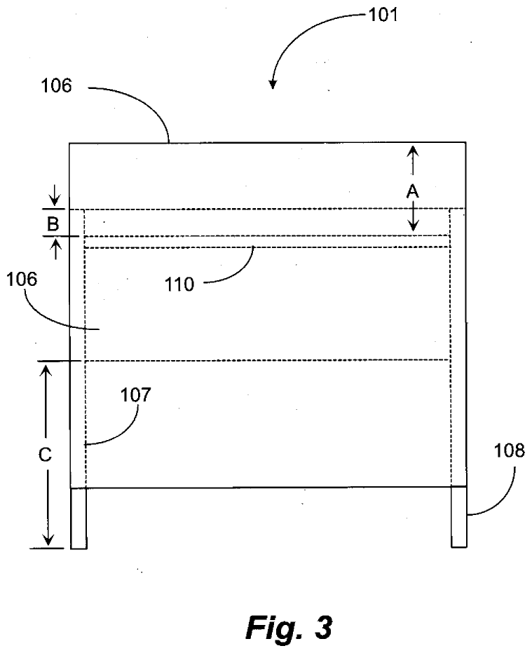

FIG. 3 is a rear elevation view of console cover table 101 of FIG. 1. Console cover table 101 has a rectangular form in this example, as a box structure. This form is not a limitation in the invention, but a preference. A goal of the invention is to maintain a horizontal flat top surface 110 (broken lines) that may be recessed in elevation with respect to the surrounding sides of the apparatus.

In one embodiment, table surface 110 is fixed to the inside surfaces of sidewalls 107, 108, front wall 109, and rear wall 106 with mounting hardware such as screws, snap fasteners, or by other means. In another embodiment, table surface 110 may be a contiguous feature in a plastic molded product. In one embodiment, table surface 110 may include strategic openings, slots, or other material relief features provided for routing wires, like charging cables. Likewise, such features may be affected in the one or more perimeter walls.

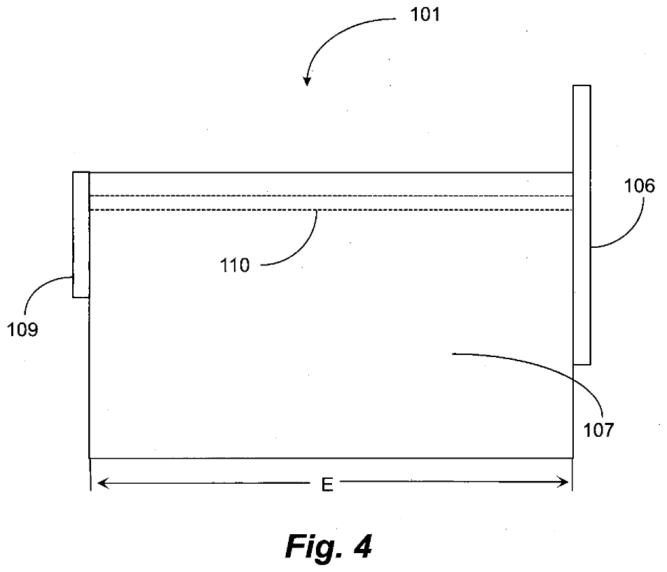

FIG. 4 is a side elevation view of console cover table 101 according to an embodiment of the present invention. Console cover table 101 has a length dimension E measured from the inside surface of front wall 109 to the inside surface of rear wall 106. Dimension E may be just longer than the length dimension of an existing center console. However, that should not be construed as a limitation in design. In one embodiment, dimension E may be less than the overall length of an existing center console where rear wall 106 may be open to fit over the rear portion of the console.

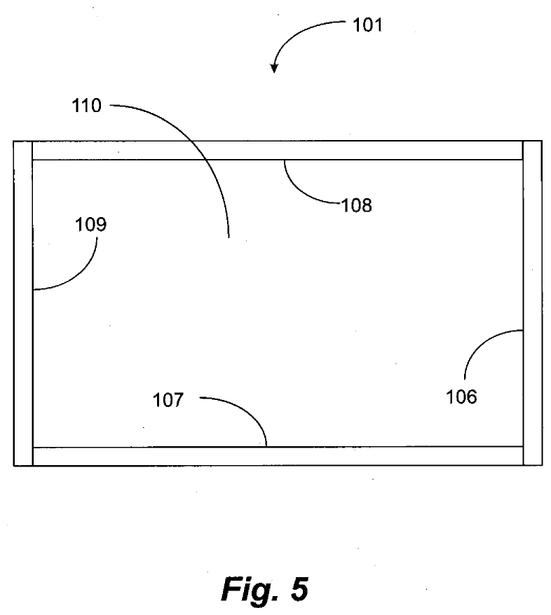

FIG. 5 is a top view of console cover table 101 of FIG. 1. Console cover table 101 fits over the form of an existing center console. Table surface 110 may be recessed with to utilize the perimeter of the table formed by the walls as a slide barrier to prevent charging devices or other articles from sliding off in any direction. Rear wall 106 extends to a higher elevation than front wall 109 in this example but may not be higher in some other embodiments. A higher barrier in the rear prevents taller devices from tumbling over to the rear upon vehicle acceleration, for example. A higher ridge in the front may be provided to prevent taller devices from tumbling forward upon vehicle braking, for example.

In one embodiment, table surface 110 may have ridges to stabilize articles on the surface. The surface of the table may have a surface coating with a relatively high coefficient of friction to discourages sliding or covered with a material for the same purpose. In another embodiment, table surface 101 may be a smooth surface that may accept suction cup type attachment of device holders with secured devices helping to stabilize those devices for charging. In a variation of this embodiment table surface 110 may comprise one or more metal, magnetically permeable pads that attract magnets, enabling device holders with magnetic connectors to stick to the table surface for charging.

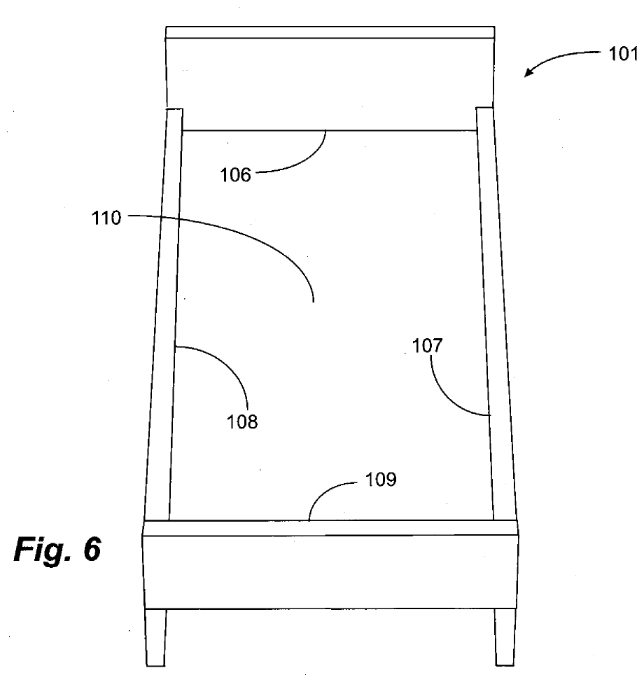

FIG. 6 is a front perspective view of a console cover table 101 of FIG. 1, in an alternative embodiment. Console cover table 101 may be one contiguous molded piece that is placed over an existing console and can be easily removed. In another embodiment, console cover table 101 may be a frame piece comprising side walls 107, 108, front wall 109, and rear wall 106 wherein table surface wall 110 is a modular piece that may be seated down into a recessed position on the frame.

The recessed position may be created by providing shoulder elements on the inside surfaces of the walls to support the table surface in a horizontal position. In this embodiment, a user may lift table surface 110 out from above via a handle or push the table surface out from underneath the frame. In this way a user may remove devices and lift surface table wall 110 out to access the console to retrieve an item or to access a charging outlet.

It will be apparent one with skill in the art that the present invention may be provided using some of or all of the elements and features described and that changes or modifications may be made to those elements in various embodiments without departing from the spirit and scope of the present invention. The invention is limited only by the breadth of the claims below.

I claim:

1. A console cover apparatus, comprising:
a first and a second side wall having a common height, spaced apart by a dimension greater than a width of a console between front seats of a vehicle;
a front wall and a rear wall joined to the side walls, the front wall and the rear wall extending to a height at least equal to the common height of the first and second side walls; and
a top surface joined to the side walls or the front and rear walls, or both, in a manner to present the top surface horizontally, the top surface recessed below the common height of the side walls and the front and rear walls, such that an upper extension of the side walls and the front and rear walls provides a barrier around the four sides of the top surface.

2. The console cover apparatus of claim 1 wherein the front wall or the rear wall, or both, extend upward to a height greater than the common height, such that the barrier at the back or the front, or both, around the top surface is greater than at the sides.

3. The console cover apparatus of claim 1 wherein the apparatus is a single molded contiguous piece of a polymer material.

4. The console cover apparatus of claim 1 comprising support elements joined to an inside surface of the side walls or the front and rear walls, or both, and the top surface is a separate piece that rests on the support element as a shelf, such that the top surface may be lifted up and out for access to the console.

5. The console cover apparatus of claim 4 wherein the top surface has a handle facing upward to facilitate withdraw of the top surface from the support elements.

6. The console cover apparatus of claim 5 wherein the top surface has one or more magnetically permeable metal plates in or below the surface.

7. The console cover apparatus of claim 1 wherein the top surface is covered with a material having a high coefficient of friction.

8. The console cover apparatus of claim 7 wherein the material is applied as a coating to the top surface.

9. The console cover apparatus of claim 1 wherein the top surface comprises openings, slots, or other relief features for routing wires.

10. A method for constraining articles in a vehicle, comprising:
creating a console cover apparatus having a first and a second side wall having a common height, spaced apart by a dimension greater than a width of a console between front seats of a vehicle, a front wall and a rear wall joined to the side walls, the front wall and the rear wall extending to a height at least equal to the common height of the first and second side walls, and a top surface joined to the side walls or the front and rear walls, or both, in a manner to present the top surface horizontally, the top surface recessed below the common height of the side walls and the front and rear walls, such that an upper extension of the side walls and the front and rear walls provides a barrier around the four sides of the top surface; and
placing the console cover apparatus over the console between the front seats with the side walls to each side of the console, such that the top surface provides a support with barriers on all four sides, such that articles placed on the top surface cannot slide off.

11. The method claim 10 comprising making the front wall or the rear wall, or both, extend upward to a height greater than the common height, such that the barrier at the back or the front, or both, around the top surface is greater than at the sides.

12. The method of claim 10 comprising molding the apparatus as a single molded contiguous piece of a polymer material.

13. The method of claim 10 comprising joining support elements to an inside surface of the side walls or the front and rear walls, or both, so that the top surface is a separate piece that rests on the support element as a shelf, such that the top surface may be lifted up and out for access to the console.

14. The method of claim 13 comprising joining a handle facing upward to the top surface to facilitate withdraw of the top surface from the support elements.

15. The method of claim 10 comprising placing one or more magnetically permeable metal plates in or below the top surface.

16. The method of claim 10 comprising covering the top surface with a material having a high coefficient of friction.

17. The method of claim 16 comprising applying the material as a coating to the top surface.

18. The method of claim 10 wherein the top surface comprises openings, slots, or other relief features for routing wires.
